(19) United States
(12) Patent Application Publication
(10) Pub. No.: US 2008/0172612 A1
(43) Pub. Date: Jul. 17, 2008

(54) DYNAMIC HELP REFERENCES FOR SOFTWARE DOCUMENTATION

(76) Inventors: Melanie Allen, Fairfax, CA (US); Alison Keller, Novato, CA (US); Asheem Mamoowala, San Francisco, CA (US); Jeremy Carter, San Anselmo, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/622,283

(22) Filed: Jan. 11, 2007

(51) Int. Cl. G06F 3/00

(52) U.S. Cl. 715/708

(57) ABSTRACT

Embodiments of the invention provide techniques for providing help content to users of software application, where the help content includes references to interface elements of a graphical user interface. A method for providing help information includes receiving a request for help content, where the requested help content includes a reference to an element of the GUI, determining a current location of an interface element in the GUI corresponding to the reference in the help content, and modifying the help content to specify the current location of the GUI element.

### BACKGROUND OF THE INVENTION

1. Field of the Invention

The present invention generally relates to computer software. More specifically, the present invention relates to techniques for providing dynamic help references to elements of a graphical user interface in electronic software documentation.

2. Description of the Related Art

Computer software applications typically provide an interface for inputting commands and retrieving information. In order to provide this interface, most computer software applications include a graphical user interface (GUI). Generally, a GUI includes a collection of graphical elements, such as menus, dialog boxes, toolbars, commands, or icons which the user may select by using a mouse pointing device or various keyboard shortcuts.

In many cases, a computer software application may provide extensive functionality, which can result in a complex GUI that has a large number of elements. In such cases, a user may not know how to perform a given action, or in which part of the GUI to find a command. In order to provide users with assistance, most software applications include electronic help documentation which may be accessed while the software application is in use.

The help documentation is often organized by common task or objective (e.g., printing a document, compressing a data file, etc.,) or by common problem category (e.g., printing errors, file corruption, etc.) Each help topic typically includes a series of step-by-step instructions that a user needs to perform in order to accomplish a particular task or to correct a particular problem. These instructions often specify which elements of the GUI that the user needs to interact with to achieve a desired result. For example, as part of an explanation on how to save a copy of a file, the help content may instruct a user to select a “File” menu, select a “Save as . . . ” command, and enter a file name.

To ensure that the descriptions of the GUI elements are as accurate as possible, the help documentation is typically written at the same time as the software application. However, in some cases, the GUI of a software application may be changed after the help documentation is written, or when the software is used for its intended purpose. One negative consequence of changes to the structure of a GUI is that the help content may become inaccurate. In particular, any instructions that describe how to use the software that include directions for navigating through the GUI may become incorrect.

The structure of the GUI may be changed in a variety of ways. In one case, a GUI configuration may intentionally be changed by a user. For example, some software applications allow individual users to customize the GUI to suit their particular needs. The user may change the GUI repeatedly to suit any changes in requirements. If the user changes the location, or ordering of menu items, however, the customized configuration is not reflected in help documentation.

In another case, the GUI of an existing software application may be altered by an add-ons or plug-in software applications that customize the “base” application for specialized uses. For example, a software application that is customized for geographic mapping may function as an add-on to an existing computer-aided design (CAD) software application. The geographic mapping application may modify a standard or default GUI of the CAD application. For example, the geographic mapping application may alter the GUI structure to remove or hide commands that are not useful for mapping functions and to add or display commands that are useful for mapping.

In yet another case, the GUI may be changed at various times based on the current mode of use. For example, a software application that can be used for both designing web pages and for browsing web pages may have two modes, one for design only and another for browsing only. When the application is used in one of these modes, the application may present the user with a GUI structure that is customized to include only those menu elements and commands that are relevant to a particular mode of use.

In each of these scenarios, if the GUI is changed after the help documentation is written, then the help documentation may no longer accurately describe the GUI. Such errors in the help documentation may result in users not being able to properly use the software application. In some cases, the help documentation can be corrected by manually revising it to update any references to the GUI. However, a manual revision process is usually costly and time-consuming. Further, if the changes to the GUI occur due to user customization, software add-ons, or modal use, a manual revision of the help documentation is often impractical. Furthermore, since changes to the GUI due to user customization and modal use can occur repeatedly, any manual revisions would also have to be repeated. Thus, in certain situations, the manual revision of the help documentation is not suitable for correcting errors.

As the foregoing illustrates, there is a need in the art for techniques for dynamic GUI references for software documentation.

### SUMMARY OF THE INVENTION

Embodiments of the invention include a method of providing help information to a user of a software application. The method generally includes receiving a request for help content. Rather than specify a static path to an interface element of the GUI, such as menu location, the requested help content may include a reference to one or more elements of the GUI. The method also includes determining a current location of an interface element in the GUI corresponding to the reference in the help content and modifying the help content to specify the current location of the GUI element in the graphical user interface. Once modified, the help content may be presented to the user of the software application.

Embodiments of the invention also include computer-readable medium storing instructions for providing help information to a user of a software application, including instructions for performing the above method. And another embodiment includes a method for obtaining help information from a software application that includes invoking a help content viewer to generate a request to view help content regarding a graphical user interface (GUI) provided by the software application, where the help viewer is configured to perform the above described method.

Advantageously, using dynamic references to elements of a graphical user interface allows accurate help content to be provided to users, regardless of customizations made to the graphical user interface. Especially where help content provides a sequence of actions to invoke that depend on the configuration of a graphical user interface, e.g., a location of a command in a menu structure. Doing so increases the usefulness of user customizations to the GUI structure, as well as the usefulness of application add-ons or plug-ins, or application modes that modify the structure of the GUI. Further, because help documentation may be updated dynamically whenever the GUI structure is modified, the accuracy of related help documentation may be maintained in real time.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system for providing dynamic GUI references in help documentation, according to one embodiment of the invention.

FIG. 2 illustrates an exemplary help topic, according to one embodiment of the invention.

FIG. 3 illustrates an exemplary application GUI and help screen, according to one embodiment of the invention.

FIGS. 4A-4B illustrate an exemplary GUI path table, according to one embodiment of the invention.

FIG. 5 illustrates an exemplary application GUI and an exemplary help screen after a GUI modification, according to one embodiment of the invention.

FIG. 6 illustrates a method for storing changes to GUI references, according to one embodiment of the invention.

FIG. 7 illustrates a method for providing GUI references in software help documentation, according to one embodiment of the invention.

### DETAILED DESCRIPTION

Embodiments of the invention provide techniques for presenting users with accurate help information that includes references to a customized menu structure. For example, if a help topic specifies a series of steps instructing a user in how to perform a desired task, the steps may be updated to reflect a current configuration of the GUI. In one embodiment, help topics may include references to GUI elements in place of a static location of a GUI element. When a user requests to view such a help topic, the application replaces the GUI reference in the help topic with a path to the current location of that GUI element. A path table may be used to store the location of each available element in the GUI interface. If any changes are made to the elements of the GUI, the GUI references may automatically be updated in the GUI path table. Thus, help documentation topics viewed by users accurately reflect the current configuration of the GUI, without requiring help documents to be manually updated with each change.

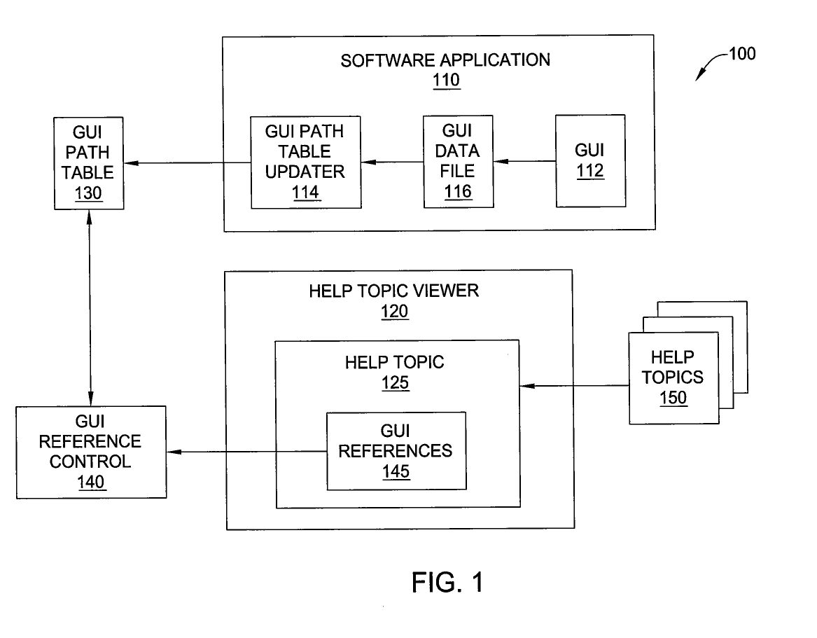

FIG. 1 is a block diagram illustrating a computer system 100 configured to provide dynamic GUI references in help documentation, according to one embodiment of the invention. The components illustrated in system 100 are included to be representative of computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be implemented as software applications that execute on a single computer system or on distributed systems communicating over computer networks such as local area networks or large, wide area networks, such as the Internet. For example, system 100 may include a software program executing on a client computer system at one physical location communicating with a software application 110 at another physical location. Also, software application 110 and a help topic viewer 120 may be provided as an application program (or programs) stored on computer readable media such as a CD-ROM, DVD-ROM, flash memory module, or other tangible storage media.

As shown, system 100 includes, without limitation, software application 110, help topic viewer 120, a GUI path table 130, a GUI reference control 140, and a set of help topics 150. Software application 110 includes a GUI 112, a GUI path table updater 114, and a GUI data file 116. The GUI 112 is the portion of the software application 110 that is visible to the user, and which the user may interact with by selecting GUI elements. As stated, GUI elements may include any combination of menus, dialog boxes, toolbars, commands, icons, and the like that allow the user to interact with the application 110. GUI data file 116 stores the contents and structure of GUI 112. That is, GUI data file 116 defines the GUI elements that make up GUI 112. Changes to the elements of GUI 112 may be made by reflected in GUI data file 116. As described above, changes to GUI 112 (and GUI data file 116) may occur in a variety of ways, including, for example, user customization, application add-ons or plug-ins, or modal use of software application 110.

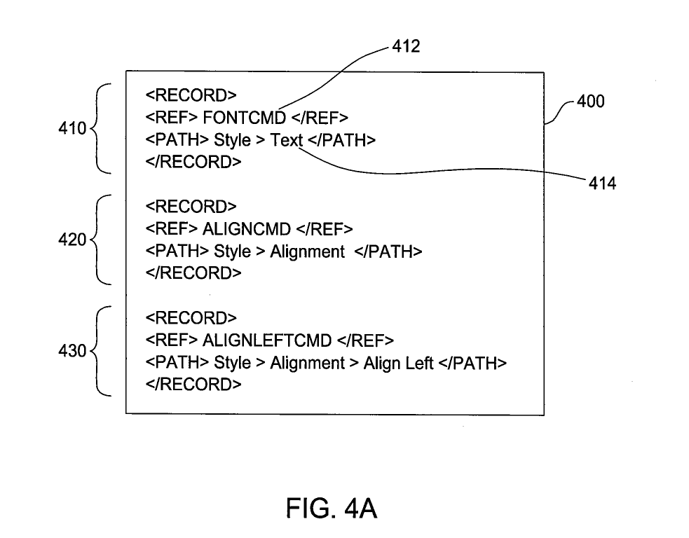

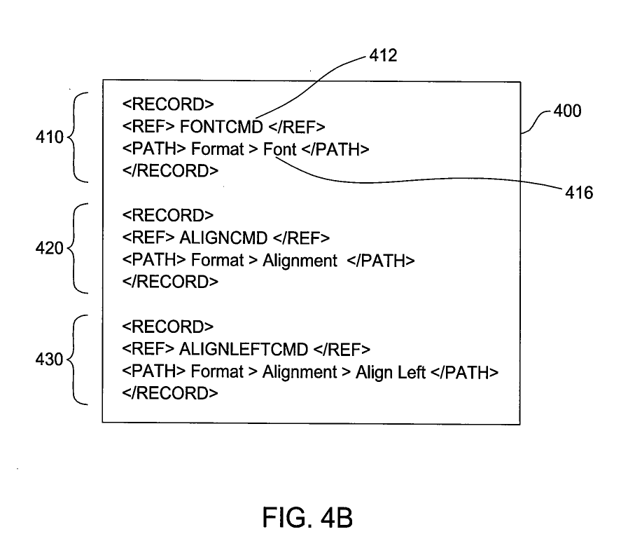

In one embodiment, GUI path table updater 114 is configured to detect changes to the GUI data file 116. When changes are detected, GUI path table updater 114 updates GUI path table 130 with changes to the GUI paths of the GUI 112. Alternatively, GUI path table 130 may be refreshed at periodic intervals, or only when help content is requested and the then current GUI path of an element (e.g., the location of a menu command) is needed. As used herein, a GUI path refers to a sequence of menus, dialog boxes, toolbars, commands and/or icons that should be followed in the GUI in order to reach the desired command. For example, a menu element for a “Print” command may have the GUI path “File>Print,” meaning that a user must open the “File” menu and then select the “Print” command to print a document. In one embodiment, GUI path table 130 stores a record for each element of GUI 112, whether the element is included as part of the current menu configuration or not, with each record including a unique identifier and GUI path for that element. GUI path table 130 is further described below with reference to FIGS. 4A-4B.

Help topic viewer 120 is configured to display a help topic 125 selected from the set of help topics 150. In one embodiment, help topic 125 may include one or more GUI references 145. Each GUI reference 145 represents a portion of text of the help topic 125 used to specify a GUI path to a particular GUI element. Each GUI reference 145 provides an identifier used to retrieve the GUI path from the GUI path table 130 for a given GUI element. For example, a help topic 125 on the subject of printing may include the GUI path “File>Print” to instruct the user on where to find the “Print” command. In one embodiment, the text string “File>Print” is replaced in the help topic 125 with GUI reference 145. Continuing with the printing example, the GUI path for the “Print” menu element may be replaced with a GUI reference like “<GUIREF: PRINTCMD>”. This exemplary GUI reference includes a unique identifier “PRINTCMD” which identifies the “Print” command. In this example, prior to displaying the help topic 125 to the user, the “<GUIREF: PRINTCMD> GUI reference is replaced with the then current location of the “Print” command. The linkage between the identifier and correct GUI path for a given GUI reference 145 may be stored in GUI path table 130. Although described herein as a separate file, one of ordinary skill in the art will readily recognize that the contents and structure of GUI 112 may be stored in an in-memory data object, or may be accessed directly from the application 110, rather than being stored in GUI data file 116.

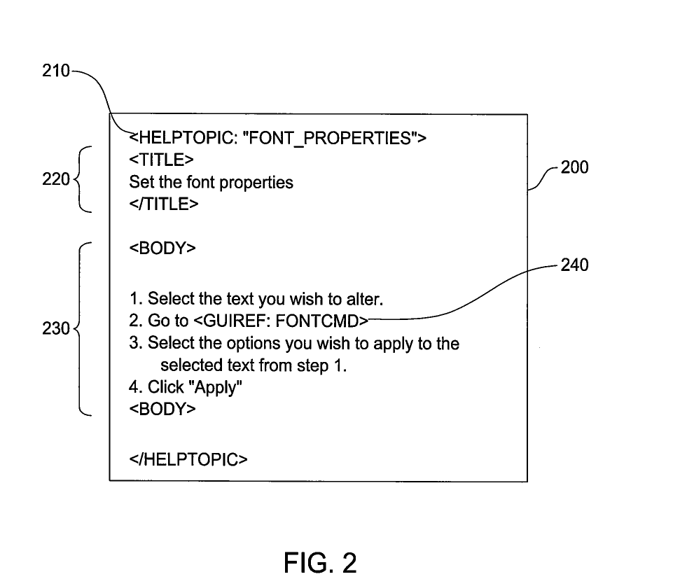

FIG. 2 illustrates an exemplary help topic 200, according to one embodiment of the invention. As shown, help topic 200 includes a topic identifier 210 of “FONT_PROPERTIES,” a topic title 220 of “Set the Font Properties,” and a topic body 230. Illustratively, help topic 200 is shown marked up using the widely used XML markup language. In one embodiment, help topics may be stored as XML documents and when help topic 200 is presented to a user, the markup is used to format the display of help topic 200. In this example, the help topic 200 includes formatting commands in the Extensible Markup Language (XML) format, which are enclosed by the bracket symbols (i.e., “<” and “>”). Of course, this formatting is shown for illustrative purposes only, and in no way limits the scope of the invention. Also included in help topic 200 is a GUI reference 240 of “<GUIREF: FONTCMD>” 240. In one embodiment, when help topic 200 is displayed to the user, GUI reference 240 is replaced by the then current path to the font properties command.

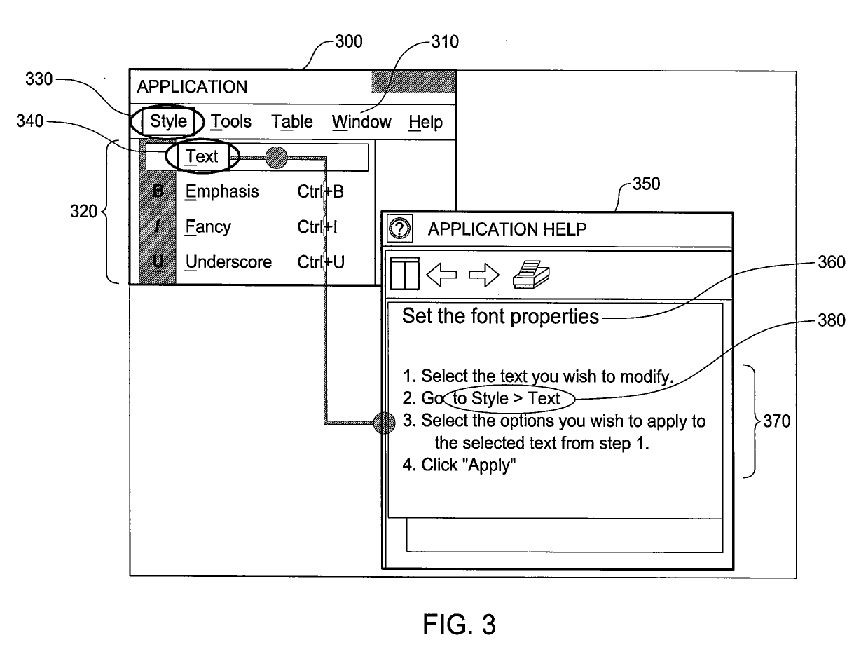

FIG. 3 illustrates an exemplary application GUI 300 and an exemplary help screen 350, according to one embodiment of the invention. In this case, GUI 300 displays an on-screen rendering of help topic 200 of FIG. 2. Application GUI 300 includes a menu bar 310. As shown, a menu element 330 “Style” of menu bar 310 has been selected and displays a menu command 340 of “Text”, as well as other commands 320. Help screen 350 includes a topic title 360 of “Set the font properties” (corresponding to topic title 220 of FIG. 2). In this example, the help screen 350 describes how a user may set the font properties within the application GUI 300. The help screen 350 also includes a topic body 370 (corresponding to topic body 230 of FIG. 2). Topic body 370 displays a menu path 380 of “Style <Text.” In other words, help topic 350 indicates that to set font properties, the user should first select the “Style” menu element 330 and then select the “text” command 340. Importantly, the contents of help screen 350 correspond to the content help topic 200 of FIG. 2, where GUI reference 240 is replaced by text string 380. In one embodiment, the help viewer replaces GUI references 145 by using GUI path table 130 to identify the current location of a command identified by a given GUI reference.

FIGS. 4A-B illustrate an exemplary GUI path table 400, according to one embodiment of the invention. Illustratively, GUI path table 400 contains records composed using the XML markup language. More specifically, GUI path table 400 includes three records 410, 420, 430, where each record includes a GUI reference identifier (enclosed by <REF> and </REF> tags) and a GUI path (enclosed by <PATH> and </PATH> tags). For example, the first record 410 includes a GUI reference identifier 412 of “FONTCMD,” and a GUI path 414 of “Style>Text.” Importantly, the GUI path 414 of “Style>Text” is the text string substituted for the GUI reference 240 in the help topic 200 of FIG. 2, when help topic 200 is viewed by the user.

FIG. 4B illustrates changes to GUI path table 400 after a user has made changes to the structure of GUI 300. In this example, the user has modified GUI 300 so that a command for setting font properties has been renamed from “Text” to “Font”, and the menu in which this command is located has been changed from “Style” to “Format.” In one embodiment, the change to GUI 300 may be performed by altering GUI data file 116, which triggers the GUI path table updater 114 to update GUI path table 400. As shown in FIG. 4B, an updated first record 410 of GUI path table 400 still has GUI reference identifier 412 of “FONTCMD,” but the path to access this command has changed to reflect changes made to GUI 400. Specifically, GUI path 416 has changed from “Style>Text” to “Format>Font.”

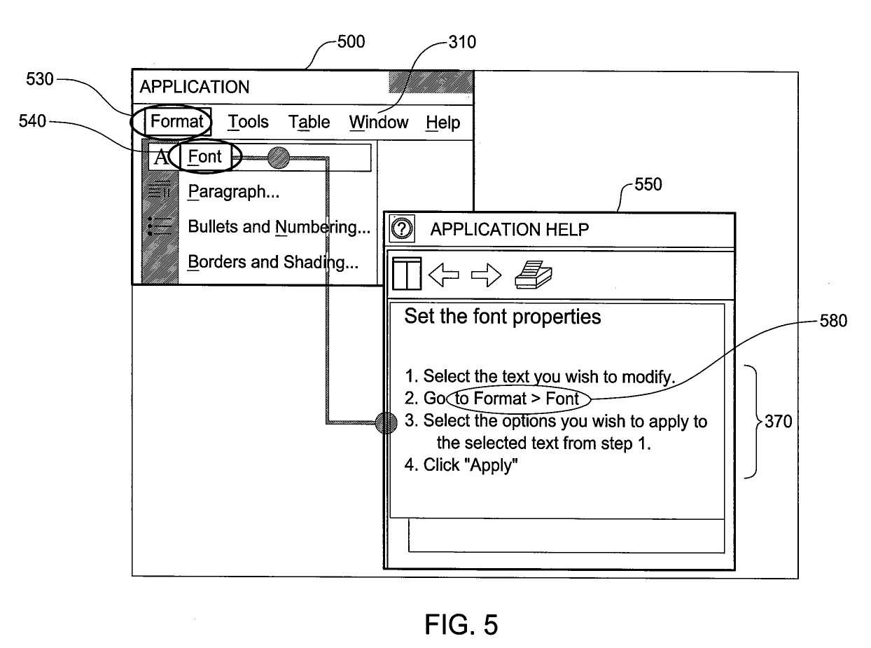

FIG. 5 illustrates an application GUI 500 and a help screen 550 after a GUI modification, according to one embodiment of the invention. Illustratively, the user customization of the GUI 500 had changed the text of menu 310 when compared with the GUI 300 of FIG. 3. Specifically, a renamed menu 530 of “Format,” and a renamed command 540 of “Font” has replaced the text of these labels as shown in FIG. 3. In one embodiment, when a user requests a help topic that includes instructions to access menu 530 or command 540, the help content reflects these modifications. For example, help screen 550 shows content 370 for the “Set the Font Properties” help topic with a correct GUI path 580 of “Format <Font,” reflecting the changes made to the configuration of menu 310 reflected in GUI 500 and GUI path table 410 from FIG. 4B.

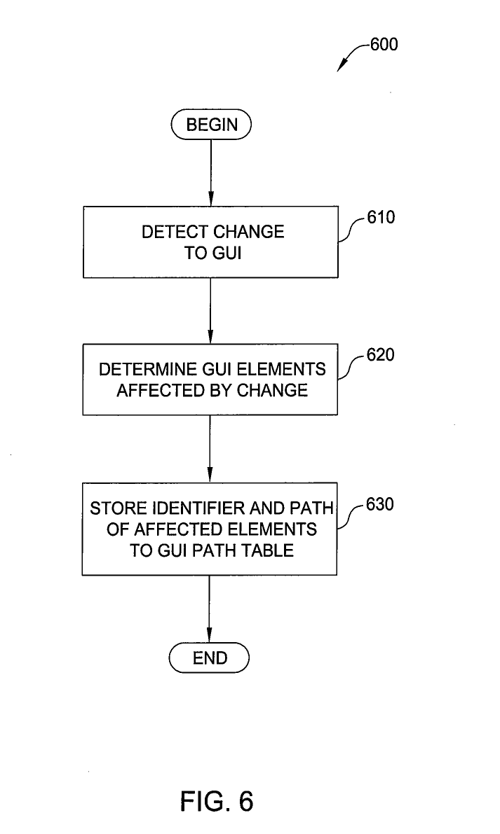

FIG. 6 illustrates a method 600 for storing changes to GUI references, according to one embodiment of the invention. Persons skilled in the art will understand that any system configured to perform the steps of method 600, in any order, is within the scope of the present invention.

The method 600 begins at step 610, where a change to the GUI is detected. For example, as described herein, an application may allow users to modify/customize a GUI, application add-ons or plug-ins may modify a GUI, or an application may be configured to have multiple operating modes, each with a different default GUI configuration. At step 620, the GUI elements that are affected by the change are determined. The affected GUI elements could include menus or commands that are renamed, the addition or deletion of entire menus or other GUI elements, the changing of menu text labels or locations, etc. In addition, an element not explicitly modified by changes made to a GUI may nevertheless be affected by changes to a GUI configuration. For example, the path to a sub-menu item is affected by a change to the name of a parent menu. More generally, any element of a GUI interface that has a GUI path changed by a modification to the GUI configuration or structure may be identified at step 620.

At step 630, an identifier and an updated GUI path for affected GUI elements are stored in a GUI path table (e.g., GUI path table 130). The GUI identifier may be used to identify each different GUI element, and the GUI path specifies a sequence of menus, commands, or actions that a user should follow to invoke the desired element or command. By updating a GUI path table in response to changes made to GUI configuration, a help viewer may always determine the current location of a menu element or command when displaying help content.

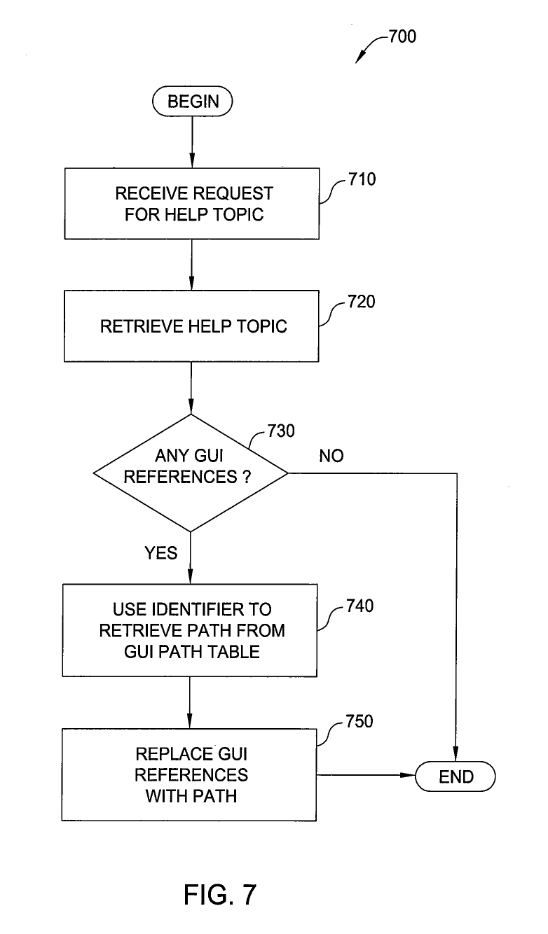

FIG. 7 illustrates a method 700 for providing GUI references in software help documentation, according to one embodiment of the invention. Persons skilled in the art will understand that any system configured to perform the steps of method 700, in any order, is within the scope of the present invention.

The method 700 begins at step 710, where a user request to view a help topic is received. At step 720, a help viewer may retrieve the requested help topic. As described above, the help topic may be marked up using a markup language such as XML and stored as an XML document. Further, the help topic may include both substantive help content, as well as references to elements of a GUI. In one embodiment, each element of the GUI may be associated with a different identifier, and each element in a current configuration of the GUI may be stored in a GUI path table. At step 730, the content of the help topic is parsed to identify any GUI references included in the help topic. If the help content does not include any GUI references, the method 700 concludes and the content of the requested help topic may be presented to the user. However, if the help content includes one or more GUI references, the then at step 740, the identifiers from the GUI references are used to identify the correct GUI path for such elements, based on the then current configuration of the GUI. As described above, for example, a GUI path table may store a location for each element of a graphical user interface. At step 750, GUI references included in the requested help topic are replaced with the location of those elements in the current GUI configuration.

In some cases, however, the current GUI configuration may not include a menu element identified by one of the GUI reference. That is, the current configuration may not include some elements of the GUI at all. When this occurs, the help topic may include alternate text to use in place of a GUI path. For example, the alternate text may explain how a user may invoke the command that has been removed from the GUI by using keyboard shortcuts or a command line interface. Or the alternate text may include a default GUI path for the element along with an explanation that the menu path displayed in the help corresponds to the default menu configuration of the application.

Advantageously, the use of dynamic GUI references allows help content to consistently provide accurate help to users. Doing so increases the usefulness of user customizations to the GUI structure, as well as the usefulness of application add-ons or plug-ins or application modes that modify the structure of the GUI. Further, because help documentation may be updated dynamically whenever the GUI structure is modified, the accuracy of related help documentation may be maintained in real time.

While the forgoing is directed to embodiments of the present invention, other and further embodiments of the invention may be devised without departing from the basic scope thereof, and the scope thereof is determined by the claims that follow.

What is claimed is:

1. A method of providing help information to a user of a software application, comprising:
receiving a request for help content, wherein the requested help content includes a reference to an element of a graphical user interface (GUI);
determining a current location of an interface element in the GUI corresponding to the reference in the help content; and
modifying the help content to specify the current location of the GUI element.

2. The method of claim 1, further comprising the step of displaying the modified help content to the user of the software application.

3. The method of claim 1, further comprising the step of identifying a current configuration of the GUI, including a location for each interface element in the current configuration of the GUI and storing the locations in a GUI path table.

4. The method of claim 3, wherein the current location of the interface element in the GUI is determined from the GUI path table.

5. The method of claim 3, wherein the step of identifying a current configuration of the GUI occurs whenever the GUI is modified.

6. The method of claim 3, wherein the step of identifying a current configuration of the GUI occurs when the request for help content is received.

7. The method of claim 3, wherein the GUI path table is stored in an external database.

8. The method of claim 3, wherein the GUI path table is composed using the Extensible Markup Language (XML).

9. The method of claim 1, wherein the step of determining the current location of an interface element in the GUI corresponding to the reference in the help content comprises determining that the element is not present in the GUI, and wherein modifying the help content to specify the current location of the GUI element comprises specifying a command line action used to invoke the element.

10. A computer-readable medium storing instructions for providing help information to a user of a software application, including instructions for performing the steps of:
receiving a request for help content, wherein the requested help content includes a reference to an element of a graphical user interface (GUI);
determining a current location of an interface element in the GUI corresponding to the reference in the help content; and
modifying the help content to specify the current location of the GUI element.

11. The computer-readable medium of claim 10, wherein the instructions further comprise instructions for displaying the modified help content to the user of the software application.

12. The computer-readable medium of claim 10, wherein the instructions further comprise instructions for identifying a current configuration of the GUI, including a location for each interface element in the current configuration of the GUI and storing the locations in a GUI path table.

13. The computer-readable medium of claim 12, wherein the current location of the interface element in the GUI is determined from the GUI path table.

14. The computer-readable medium of claim 12, wherein the step of identifying a current configuration of the GUI occurs whenever the GUI is modified.

15. The computer-readable medium of claim 12, wherein the step of identifying a current configuration of the GUI occurs when the request for help content is received.

16. The computer-readable medium of claim 12, wherein the GUI path table is stored in an external database.

17. The method of claim 10, wherein the GUI path table is composed using the Extensible Markup Language (XML).

18. The method of claim 10, wherein the step of determining the current location of an interface element in the GUI corresponding to the reference in the help content comprises determining that the element is not present in the GUI, and wherein modifying the help content to specify the current location of the GUI element comprises specifying a command line action used to invoke the element.

19. A method for obtaining help information from a software application, comprising:
invoking a help content viewer to generate a request to view help content regarding a graphical user interface (GUI) provided by the software application, wherein the help viewer is configured to:
receive the request for help content, wherein the requested help content includes a reference to an element of a graphical user interface (GUI),
determine a current location of an interface element in the GUI corresponding to the reference in the help content, and
modify the help content to specify the current location of the GUI element.

20. The method of claim 19, wherein the help content viewer is further configured to display the modified help content to the user of the software application.

21. The method of claim 20, wherein the software application is configured to identify a current configuration of the GUI, including a location for each interface element in the current configuration of the GUI and to store the locations in a GUI path table.

22. The method of claim 21, wherein the current location of the interface element in the GUI is determined from the GUI path table.

23. The method of claim 21, wherein the step of identifying a current configuration of the GUI occurs whenever the GUI is modified.

24. The method of claim 21, wherein the step of identifying a current configuration of the GUI occurs when the request for help content is received.
